(19) United States
(12) Patent Application Publication
(10) Pub. No.: US 2026/0291730 A1
(43) Pub. Date: Sep. 24, 2026

(54) CONTROLLER AND COMPUTING SYSTEM

(71) Applicant: Kioxia Corporation, Tokyo (JP)

(72) Inventor: Yoshihiro OHBA, Kawasaki (JP)

(73) Assignee: Kioxia Corporation, Tokyo (JP)

(21) Appl. No.: 19/319,877

(22) Filed: Sep. 5, 2025

(30) Foreign Application Priority Data
Mar. 18, 2025 (JP) 2025-043897

(51) Int. Cl. H04L 9/14

(52) U.S. Cl. CPC H04L 9/14

(57) ABSTRACT

According to one embodiment, a controller configured to execute a first computation by which a coefficient cyclic computation of a polynomial is executed in a homomorphic manner on first ciphertext, the controller including: a computing processing unit configured to use the first ciphertext, a plurality of first coefficients, and a plurality of first parameters, wherein the computing processing unit includes: a parameter group division processing unit configured to perform a division into first coefficient groups and a division into first parameter groups; partial processing units calculating a partial output; and an output combining unit configured to combine the partial outputs to calculate a result of the first computation on the first ciphertext.

### CROSS-REFERENCE TO RELATED APPLICATION

This application is based upon and claims the benefit of priority from Japanese Patent Application No. 2025-043897, filed Mar. 18, 2025, the entire contents of which are incorporated herein by reference.

### FIELD

Embodiments described herein relate generally to a controller and a computing system.

### BACKGROUND

Storage devices that can perform calculation processes are known. Such storage devices are also referred to as computing storage devices. Storage devices of this type are used, for example, in performing a blind rotate process. The blind rotate process is a process included in a gate bootstrapping process by which noise in ciphertext is lowered, a vertical packing process by which a secure calculation is executed, and some other processes. In this blind rotate process, a homomorphic cyclic encryption computation of a coefficient of a polynomial of ciphertext is executed on torus fully homomorphic encryption (TFHE), which is a fully homomorphic encryption scheme.

### BRIEF DESCRIPTION OF THE DRAWINGS

FIG. 1 is a block diagram illustrating an example of a configuration of a storage system according to an embodiment.

FIG. 2 is a block diagram for explaining an example of a configuration of a computing processing unit in a storage device according to the embodiment.

FIG. 3 is a diagram illustrating an example of overall operation of the storage system according to the embodiment.

FIG. 4 is a flowchart illustrating an example of a blind rotate process in the storage system according to the embodiment.

FIG. 5 is a diagram illustrating an example of partial blind rotate processes in the storage system according to the embodiment.

FIG. 6 is a block diagram illustrating an example of a configuration of a storage system according to a modification.

FIG. 7 is a block diagram for explaining an example of a configuration of an accelerator included in an accelerator cluster of the storage device according to the modification.

FIG. 8 is a block diagram for explaining an example of a configuration of accelerators included in the accelerator cluster of the storage device according to the modification.

### DETAILED DESCRIPTION

In general, according to one embodiment, a controller configured to execute a first computation by which a coefficient cyclic computation of a polynomial is executed in a homomorphic manner on first ciphertext encrypted with a first key, the controller including: a computing processing unit configured to use the first ciphertext, a plurality of first coefficients related to the first ciphertext, and a plurality of first parameters in each of which a value 0 or 1 is encrypted with the first key to execute the first computation, wherein the computing processing unit includes: a parameter group division processing unit configured to perform, based on the first coefficients, a division into an S number of first coefficient groups, each of which contains a plurality of second coefficients and to perform, based on the first parameters, a division into an S number of first parameter groups, each of which contains a plurality of second parameters and which are related, respectively, to the S number of first coefficient groups; an S number of partial processing units which are provided in relation to the S number of first coefficient groups and the S number of first parameter groups, each of the S number of partial processing units using the relevant first coefficient group out of the S number of first coefficient groups and the relevant first parameter group out of the S number of first parameter groups, each of the S number of partial processing units calculating a partial output; and an output combining unit configured to combine the S number of partial outputs that have been calculated, respectively, by the S number of partial processing units to calculate a result of the first computation on the first ciphertext.

Some embodiments will be described below with reference to the accompanying drawings. It should be noted that, in the following description, components having the same functions and configurations are given the common reference numerals.

In the following description, components having substantially the same functions and configurations are given the identical reference numerals. In a case where elements having similar configurations are particularly distinguished from each other, some of these elements are given the same reference numeral plus different characters or numbers added to an end thereof.

### 1 Embodiment

A storage system according to an embodiment will be described.

### 1.1 Configuration

First, a configuration of the storage system according to the embodiment will be described.

### 1.1.1 Overall Configuration

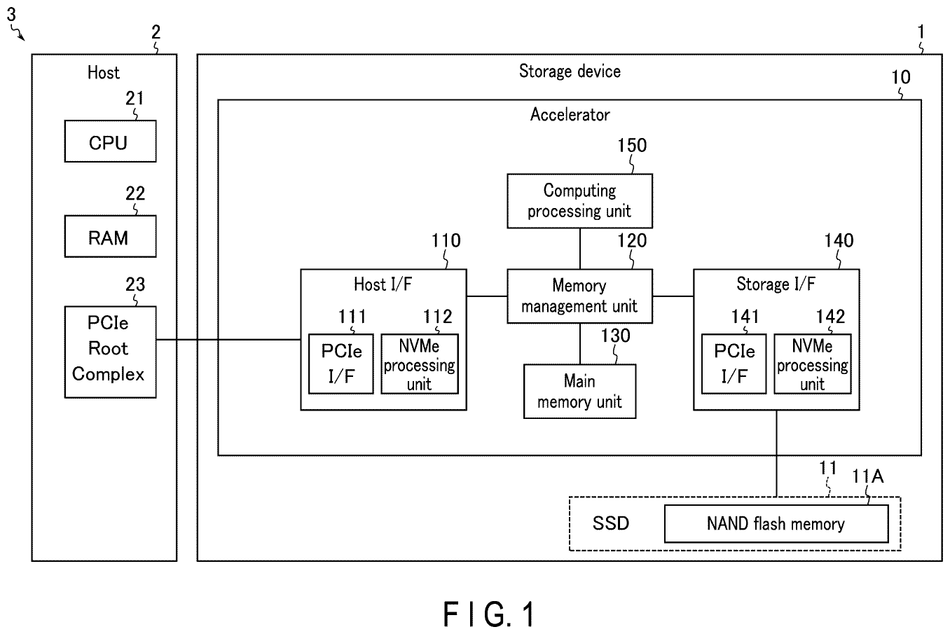

An overall configuration of a storage system 3 will be described with reference to FIG. 1. FIG. 1 is a block diagram illustrating an example of the configuration of the storage system according to the embodiment.

The storage system 3 includes a storage device 1 and a host 2.

The storage device 1 is, for example, a computing storage device. The storage device 1 includes an accelerator 10 and a storage 11.

The accelerator 10 is an apparatus for improving a processing speed of the storage system 3. The accelerator 10 corresponds to, for example, a memory controller that controls the storage device 1. The accelerator 10 may also be referred to as the controller.

The storage 11 is connected to the accelerator 10. The storage 11 is, for example, a solid state drive (SSD). The storage 11 includes a semiconductor memory 11A that stores data in a nonvolatile manner. This semiconductor memory is, for example, a NAND flash memory. However, the storage 11 is not limited to an SSD and may be any other non-volatile memory.

For example, the host 2 transmits commands for various processes to the storage device 1. The storage device 1, in turn, performs the processes in response to these commands. In addition, for example, the host 2 receives the process results from the storage device 1. The storage device 1 and the host 2 are interconnected via a host bus. The host bus is, for example, a peripheral component Interconnect express (PCIe™) bus. In this case, a protocol used for communication between the storage device 1 and the host 2 conforms to, for example, the non-volatile memory express (NVMe™) standard.

### 1.1.2 Host

Following the above, a configuration of the host 2 will be described with reference to FIG. 1.

The host 2 includes, for example, a processor (CPU) 21, RAM 22, and a port unit 23.

The processor 21 controls overall operation of the host 2. For example, the processor 21 issues commands for instructing the storage device 1 to perform various processes. These commands are, for example, commands for reading data from the storage 11, writing data into the storage 11, and performing some other processes in the storage device 1. Furthermore, the processor 21 controls the host 2, for example, in such a way that the host 2 transmits, to the storage device 1, data regarding writing of the data into the storage 11 and any other process in the storage device 1.

The RAM 22 is, for example, a static random access memory (SRAM) or some other memory. The RAM 22 temporarily stores data that the host 2 has received from the storage device 1.

The port unit 23 has a system bus port to the storage device 1. This system bus port is, for example, a PCIe™ port. The port unit 23 is also referred to as the root complex.

### 1.1.3 Storage Device

Following the above, a configuration of the accelerator 10 in the storage device 1 will be described with reference to FIG. 1.

The accelerator 10 includes a host interface circuit (host I/F) 110, a memory management unit 120, a main memory unit 130, a storage interface circuit (storage I/F) 140, and a computing processing unit 150.

The host interface circuit 110 is connected to the port unit 23 in the host 2 via the host bus. The host interface circuit 110 relays the communication between the storage device 1 and the host 2. The host interface circuit 110 includes, for example, a PCIe interface circuit (PCIe I/F) 111 and an NVMe processing unit 112. The PCIe interface circuit 111 performs a process in conformity with the PCIe™ standard. The NVMe processing unit 112 performs a process in conformity with the NVMe™ standard.

The host interface circuit 110 receives, from the host 2, the commands for reading data from the storage 11, writing data into the storage 11, and performing some other processes in the storage device 1. In addition, the host interface circuit 110 receives, from the host 2, data used for the processes to be performed in response to these commands.

The memory management unit 120 intensively controls the accelerator 10, for example. The memory management unit 120 receives, for example, a command from the host 2 and data used for the process to be performed in response to the command, via the host interface circuit 110. When a calculation process is performed in the accelerator 10, the memory management unit 120 transmits data used for this process to the computing processing unit 150. The memory management unit 120, in turn, receives data of an intermediate, final, and other results of the calculation process from the computing processing unit 150. The memory management unit 120 stores, in the main memory unit 130, for example, various data received from the host 2 and the computing processing unit 150.

The main memory unit 130 is, for example, a dynamic random access memory (DRAM) or other memory. The main memory unit 130 is configured to be accessible at a higher rate than the storage 11. The main memory unit 130 stores, for example, data transmitted from the memory management unit 120.

The storage interface circuit 140 is connected to the storage 11 via, for example, a storage bus. The storage interface circuit 140 relays the communication between the storage 11 and the accelerator 10. The storage bus is, for example, the PCIe™ bus. In this case, a protocol used for the communication between the storage device 1 and the host 2 conforms to, for example, the NVMe™ standard. The storage interface circuit 140 may be connected to the storage 11 via a network, although this is not illustrated in the drawings. The storage interface circuit 140 includes, for example, a PCIe interface circuit 141 and an NVMe processing unit 142.

The computing processing unit 150 performs a calculation process in response to a command from the host 2. This calculation process will be described later; however, the calculation process is, for example, a process using a blind rotate algorithm, which is to be executed in a gate bootstrapping process and a vertical bootstrapping process. Hereinafter, the process using the blind rotate algorithm is also referred to simply as the blind rotate process or the BR process. It should be noted that the process of each of the elements in the memory management unit 120 and the computing processing unit 150 is implemented in hardware, software, or a combination thereof. The “implemented in software” herein refers to, for example, implemented by executing a predetermined program with a processor disposed in each element. The “being implemented in hardware” refers to, for example, being implemented by at least one of a register, a memory, an adder, a multiplier, a selector, and other functional units. A register is implemented with, for example, a sequential circuit, such as a flip-flop. An adder, a multiplier, a selector, and other functional units are each implemented with, for example, a logic circuit.

The blind rotate process in the embodiment will be described later; however, the blind rotate process is a computation by which a coefficient cyclic computation of a polynomial is executed in a homomorphic manner. In this case, the coefficient cyclic computation is a computation of circulating a coefficient of any polynomial f(X). Hereinafter, an expression by which a coefficient cyclic computation for cyclizing the coefficient of the polynomial f(X) by a value i1 is executed is referred to as a polynomial f(X)·X¹¹. The value i1 is an integer. The value i1 is also referred to as a cyclic amount.

The coefficient cyclic computation will be described in more detail by using a polynomial on the torus polynomial ring T_{N′}[X]=T[X]/(X^{N′}+1). The value N′ in the torus polynomial ring is an integer. Hereinafter, the polynomial g(X) on the torus polynomial ring T[X]/(X⁴+1) where the value N′ is 4, which is expressed by the following equation (1), will be described as an example of the polynomial f(X).

$$g ( X ) = 0.5 - 0.4 X + 0.3 {X}^{2} + 0.2 {X}^{3} \qquad ( 1 )$$

In the coefficient cyclic computation for the polynomial g(X), for example, cyclizing the coefficient of the following X by the value i1 refers to adding the value i1 to the order of each term for X of the polynomial g(X). In a case where the value i1 is −2, for example, the order of each term for X is subtracted by 2, as in the following expression (2). In this case, in accordance with the relationship of the following equation (3), X⁻² and X⁻¹ are transformed, respectively, into (−X²) and (−X¹), as in the following equation (4). With this relationship, the polynomial g(X)·X⁻² is transformed, as expressed in the following equation (2).

$$\begin{matrix}g ( X ) \cdot {X}^{- 2} = 0.5 {X}^{0 - 2} - 0.4 {X}^{1 - 2} + 0.3 {X}^{2 - 2} + 0.2 {X}^{3 - 2} \\ = - 0.5 {X}^{2} + 0.4 {X}^{3} + 0 \text{.3} + 0.2 X \\ = - 0.3 + 0.2 X - 0.5 {X}^{2} + 0.4 {X}^{3}\end{matrix} \qquad ( 2 )$$

$${X}^{4} = - 1 \qquad ( 3 )$$

$${X}^{- 2} = {X}^{- 2} ( - {X}^{4} ) = - {X}^{2} , \qquad ( 4 )$$

$${X}^{- 1} = {X}^{- 1} ( - {X}^{4} ) = - {X}^{3}$$

In a case where the blind rotate process with the cyclic amount i1 is performed on ciphertext in which the polynomial g(X) is encrypted with the key K, the ciphertext (output ciphertext) that has been output through the blind rotate process is decrypted with the key K, so that the plaintext g(X)·X¹¹ is calculated.

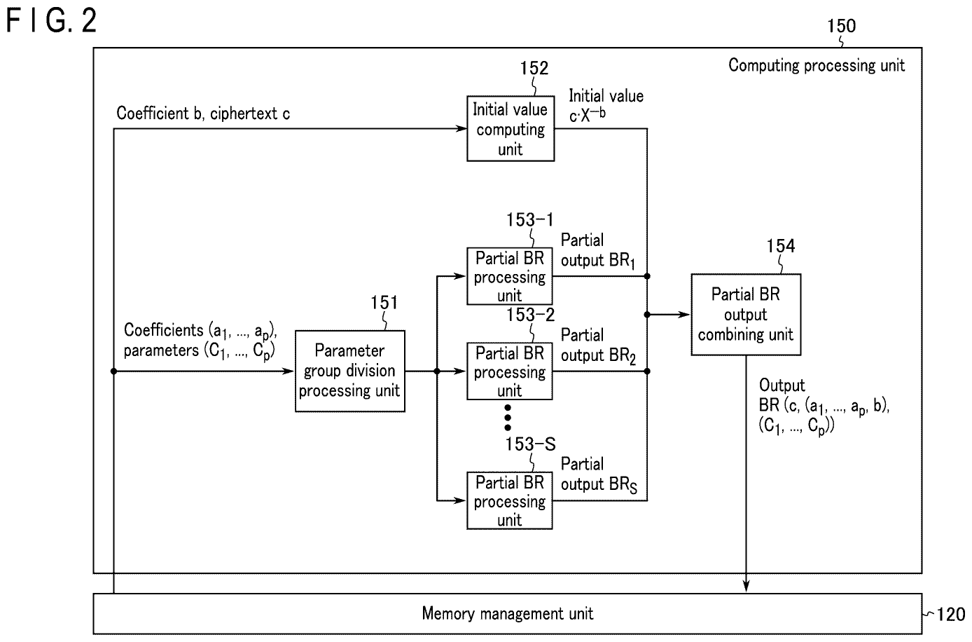

A configuration of the computing processing unit 150 will be further described with reference to FIG. 2. FIG. 2 is a block diagram for explaining an example of a configuration of a computing processing unit in the storage device according to the embodiment. FIG. 2 illustrates a configuration of the computing processing unit 150 together with the memory management unit 120.

In the blind rotate process, the computing processing unit 150 uses ciphertext c, which is a target for noise reduction, a p number of coefficients a₁, . . . , and aₚ, a coefficient b, and a p number of parameters C₁, . . . , and Cp to calculate an output BR (c, (a₁, . . . , and aₚ, b), (C₁, . . . , and Cₚ)). The value p is a positive integer. Hereinafter, the output BR (c, (a₁, . . . , and aₚ, b), (C₁, . . . , and Cₚ)) is also referred to simply as the output BR. The ciphertext c is a sample in the TRLWE format, which is obtained by encrypting the torus polynomial v expressed by the following equation (5) with the key K. The ciphertext c is expressed by the following equation (6). The value N in the following equation (5) is an integer related to the order of the torus polynomial. The value k in the following equation (6) is the number of polynomials for encoding the key K of the sample in the TRLWE format. The coefficients a₁, . . . , and aₚ, and b are integer coefficients corresponding to the coefficients of the ciphertext c. The parameters C₁, . . . , and Cₚ are samples in a torus ring gentry-sahai-waters (TRGSW) format in which a value 0 or 1 is encrypted with the key K. The ciphertext c, the coefficients a₁, . . . aₚ, and b, and the parameters C₁, . . . , and Cₚ are transmitted from the host 2, for example. The output BR is ciphertext calculated through the blind rotate process. The output BR is a sample in the TRLWE format obtained by encrypting the torus polynomial X^{-ρ}·v with the key K. In this case, the value ρ in the torus polynomial is expressed in the following equation (7) for which the value i2 is used. The value i2 is a positive integer. The computing processing unit 150 outputs the output BR to the memory management unit 120. The output BR is then transmitted to the host 2, for example.

$$v ∈ {T}_{N} [ X ] \qquad ( 5 )$$

$$c ∈ {{T}_{N} [ X ]}^{k + 1} \qquad ( 6 )$$

$$ρ = b - {\sum }_{i 2 = 1}^{p} {s}_{i 2} {a}_{i 2} mod 2 N \qquad ( 7 )$$

In the blind rotate process, the computing processing unit 150 is configured to use the coefficients a₁, . . . , and aₚ and the parameters C₁, . . . , and Cₚ to perform an S number of processes, which can be processed in parallel. The value S is a positive integer. Each of the S number of processes described above is also referred to as a partial blind rotate process or a partial BR process. In addition, during the blind rotate process, the computing processing unit 150 calculates the output BR, which is obtained by combining the results of the S number of partial blind rotate processes with the initial value c·X^{-b} obtained by executing the coefficient cyclic computation using the coefficient b. The partial blind rotate processes and the combination will be described later. Hereinafter, results of the S number of partial blind rotate processes are also referred to as partial outputs BR₁, . . . , and BR_{S}.

The computing processing unit 150 includes a parameter group division processing unit 151, an initial value computing unit 152, an S number of partial BR processing units 153, and a partial BR output combining unit 154.

The parameter group division processing unit 151 uses the coefficients a₁, . . . , and aₚ and the parameters C₁, . . . , and Cₚ to perform a division into an S number of coefficient groups a′₁, . . . , and a′_{S}, each of which contains a plurality of coefficients, and an S number of parameter groups C′1, . . . , and C's, each of which contains a plurality of parameters. The S number of coefficient groups a′₁, . . . and a′_{S} is related, respectively, to an S number of partial blind rotate processes. The S number of parameter groups C′₁, . . . , and C′_{S} is related, respectively, to an S number of partial blind rotate processes. This enables the parameter group division processing unit 151 to perform an S number of partial blind rotate processes. The division of the parameters will be described later.

The initial value computing unit 152 uses the coefficient b and the ciphertext c to calculate the initial value c·X^{-b}. The initial value computing unit 152 then outputs the calculated initial value c·X^{-b} to the partial BR output combining unit 154. It should be noted that the initial value c·X^{-b} is also referred to as the initial value of an accumulator ACC. The accumulator ACC is an intermediate output when the output BR is calculated, as will be described later.

The S number of partial BR processing units 153 is provided in relation to the S number of partial blind rotate processes. Each partial BR processing unit 153 receives, out of the S number of coefficient groups and the S number of parameter groups, a coefficient group and a parameter group related to each partial BR processing unit 153, from the parameter group division processing unit 151. Each partial BR processing unit 153 then uses the received coefficient group and parameter group to perform the partial blind rotate process. Each partial BR processing unit 153 then outputs any one of the partial outputs BR₁, . . . , and BR_{S} calculated through this process to the partial BR output combining unit 154.

The partial BR output combining unit 154 uses the initial values c·X^{-b} and the partial outputs BR₁, . . . , and BR_{S} to perform the combining, which will be described later. The partial BR output combining unit 154 then outputs the output BR calculated by the combining, to the memory management unit 120.

### 1.2 Operation

Next, an operation using the storage system 3 according to the embodiment will be described.

### 1.2.1 Overall Operation

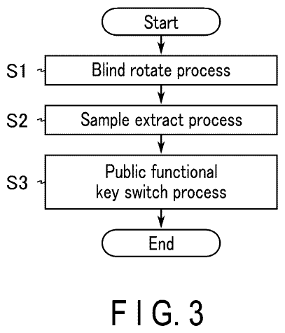

An overall operation using the storage system 3 according to the embodiment will be described with reference to FIG. 3. FIG. 3 is a diagram illustrating an example of overall operation of the storage system according to the embodiment.

The overall operation using the storage system 3 according to the embodiment is, for example, a gate bootstrapping process. When a secure calculation is executed, for example, the host 2 and some other components generate ciphertext for the secure calculation. Such ciphertext contains intentional noise in order to improve security. However, the execution of the secure calculation sometimes increases the noise. This may make the decoding difficult. For this reason, the gate bootstrapping process for lowering the noise is performed.

The gate bootstrapping process includes a blind rotate process S1, a sample extract process S2, and a public functional key switch process S3.

In the blind rotate process S1, as described above, the coefficient cyclic computation of the polynomial is executed on the ciphertext c, which is a target for noise reduction. In the blind rotate process S1, the ciphertext c, the coefficients a₁, . . . , aₚ, and b, and the parameters C₁, . . . , and Cₚ are handled as inputs. These inputs are used to calculate the output BR.

In the sample extract process S2, the ciphertext c is handled as an input. Then, by encrypting the coefficient of the p1-th term of the polynomial v for the ciphertext c, ciphertext c′ is calculated. The value p1 is equal to or more than 0 and is a value (N−1). The ciphertext c′ is a sample in a torus learning with errors (TLWE) format expressed by the following equation (8). In this case, the value n in the following equation (8) is a value obtained by multiplying the value N by the value k (n=kN). In a case where the value p1 is 0 in the sample extract process S2, a sample in the TLWE format is calculated by encrypting the constant term of the polynomial v.

$${c}^{′} ∈ {T}^{n + 1} \qquad ( 8 )$$

The public functional key switch process S3 is a process through which the sample in the TLWE format generated by encrypting the input value x with a key K₁ is used to calculate a sample in the TLWE format generated by encrypting the value x with a key K₂, which is different from the key K₁, or a sample in a TRLWE format. In the public functional key switch process S3, for example, the sample in the TLWE format which has been calculated through the sample extract process S2 is used to calculate ciphertext encrypted with a key different from the above key K. This ciphertext is ciphertext in which noise has been made lower than that in the ciphertext c.

In this way, the noise in the ciphertext that has been generated by the host 2 is lowered through the gate bootstrapping process.

### 1.2.2 Blind Rotate Process

The blind rotate process using the storage system 3 according to the embodiment will be described.

In the blind rotate process according to the embodiment, as described above, a plurality of partial blind rotate processes are performed. First, a mathematical background in calculating the output BR through the plurality of partial blind rotate processes divided will be described.

In the blind rotate process according to the embodiment, a p number of coefficients a₁, . . . , and aₚ are divided into an S number of coefficient groups a′₁, . . . , and a′_{S}, each of which contains a plurality of coefficients, in accordance with a relationship of the following Equation (9). The coefficient a′_{i3,j1} in the following equation (9) is a coefficient designated by the value j1, which is contained in the coefficient group a′ᵢ₃ designated by the value i3. The value i3 is an integer in a range from 1 to S (1≤i3≤S). The value j1 is an integer in a range from 1 to the value nᵢ₃ (1≤j1≤nᵢ₃). The value nᵢ₃ is a value expressed by the following equation (10). In this case, δ_{i3,s} in the following equation (10) is a delta function of Kronecker defined by the following equation (11). The data type of the coefficients a′_{i3,j1} after the division is an integer coefficient, similar to the coefficients a₁, . . . , and aₚ.

$${a}_{i 3 , j 1}^{′} = {a}_{( p / S ) ( i 3 - 1 ) + j 1} \qquad ( 9 )$$

$${n}_{i 3} = \frac{p}{S} + ( p mod S ) \cdot {δ}_{i 3 , S} \qquad ( 10 )$$

$${δ}_{i 3 , S} = \{ \begin{matrix}1 & i 3 = S \\ 0 & Otherwise\end{matrix} \qquad ( 11 )$$

As described above, the coefficient group a′ᵢ₃ contains an nᵢ₃ number of coefficients, as expressed by the following equation (12).

$${a}_{i 3}^{′} = ( {a}_{i 3 , 1}^{′} , … , {a}_{i 3 , {n}_{i 3}}^{′} ) \qquad ( 12 )$$

Furthermore, the p number of parameters C₁, . . . , and Cₚ are divided into an S number of parameter groups C′₁ . . . , and C′_{S}, each of which contains a plurality of coefficients, in accordance with the relationship of the following equation (13). The parameter C′_{i3,j1} in the following equation (13) is a parameter designated by the value j1, which is contained in the parameter group C′ i3 designated by the value i3. The data type of the divided parameters C′_{i3,j1} is a sample in the TRGSW format, similar to the parameters C₁, . . . and Cₚ.

$${C}_{i 3 , j 1}^{′} = {C}_{( p / S ) ( i 3 - 1 ) + j 1} \qquad ( 13 )$$

As described above, the coefficient group C′ᵢ₃ contains an nᵢ₃ number of coefficients, as expressed in the following equation (14).

$${C}_{i 3}^{′} = ( {C}_{i 3 , 1}^{′} , … , {C}_{i 3 , {n}_{i 3}}^{′} ) \qquad ( 14 )$$

The plaintext polynomial cx-P, which is to be encrypted into the output BR (the sample in the TRLWE format) of the blind rotate process, can use the S number of coefficient groups a′₁, . . . , and a′_{S} calculated in the above manner and the parameter groups C′₁ . . . , and C′_{S} to perform decomposition into a plurality of terms, as expressed by the following equation (15).

$$\begin{matrix}{cX}^{\text{?}} = ( {cX}^{- b} ) ( 1 \cdot {X}^{{\sum }_{j 2 = 1}^{{n}_{1}} {a}_{1 , j 2}^{′} , {s}_{1 , j 2}^{′}} ) … ( 1 \cdot {X}^{{\sum }_{j 2 = 1}^{{n}_{s}} {a}_{S , j 2}^{′} , {s}_{S , j 2}^{′}} ) \\ = ( 1 \cdot {X}^{{\sum }_{j 2 = 1}^{{n}_{s}} {a}_{S , j 2}^{′} , {s}_{S , j 2}^{′}} ) … ( 1 \cdot {X}^{{\sum }_{j 2 = 1}^{{n}_{1}} {a}_{1 , j 2}^{′} , {s}_{1 , j 2}^{′}} ) … ( {cX}^{- b} )\end{matrix} \qquad ( 15 )$$

$$\text{?} \text{indicates text missing or illegible when filed}$$

For the ciphertext Encrypt (X^{-ρ}v) of the plaintext polynomial cX^{-ρ}, the relationship of the following expression (16) is established by using an external product operator of TFHE, which will be described later. This relationship is based on the fact that a sample C (parameters C₁, . . . , and Cₚ) in a trivial TRGSW format with respect to the integer polynomial plaintext μ=1 is expressed by the following equation (17) using the gadget decomposition matrix H and the (k+1)l×(k+1)N dimensional 0 matrix Z. In this case, the “trivial” means that all coefficients of a (k+1)l×(k+1) number of N-dimensional polynomials are 0. In this case, the plaintext μ=1 is treated as an integer polynomial in which the constant term is 1 and the values of the coefficients of the other terms are all 0, as mathematically expressed by the following equation (18). The sample C is expressed by the following equation (19).

$$Encrypt ( {X}^{\text{?}} v ) = {BR}_{S} \text{?} ( … ( {BR}_{2} \text{?} ( {BR}_{1} \text{?} {cX}^{- b} ) ) ) \qquad ( 16 )$$

$$\text{?} : External Product Operator$$

$$C = Z + μ H = H \qquad ( 17 )$$

$$μ = 1 ∈ Z [ X ] / ( {X}^{N} + 1 ) \qquad ( 18 )$$

$$C ∈ {( {{T}_{N} [ X ]}^{( k + 1 )} )}^{( k + 1 ) \text{?}} \qquad ( 19 )$$

$$\text{?} \text{indicates text missing or illegible when filed}$$

Out of the partial outputs BR₁, . . . and BR_{S}, the partial output BRᵢ₄ designated by the value i4 is expressed by the following equation (20) using the “BlindRotate” process in Algorithm 4 described in non-patent literature 1. The argument Hⱼ₃ in the “BlindRotate” process is the row vector Hⱼ₃ of the gadget decomposition matrix H in the gadget decomposition function. The h-th element H_{j3,h} in the row vector Hⱼ₃ is expressed by the following equation (21). The value j3 is in a range from 1 to the value (k+1)l(1≤j3≤(k+1)l). The value j3 is based on the number of gadget decomposition digits of the gadget decomposition matrix H described above. The value h is a positive integer contained in a range from 1 to the value (k+1) (1≤h≤(k+1)). In this case, the data type of the row vector Hⱼ₃ of the gadget decomposition matrix H is, for example, a data type in the TRLWE format. The partial output BRᵢ₄ contains a (k+1) l number of sub-partial outputs, as expressed by the following equation (22).

$$B {R}_{i 4 , j 3} {=}^{Δ} ( BlindRotate ( {H}_{j 3} , ( {a}_{i 4}^{′} , 0 ) , {C}_{i 4}^{′} ) ) \qquad ( 20 )$$

$${H}_{j 3 , h} = \{ \begin{matrix}1 / {B}_{g}^{j 3 mod ( \text{?} + 1 )} , & j 3 / ( \text{?} + 1 ) + 1 = h \\ 0 & Otherwise\end{matrix} \qquad ( 21 )$$

$$B {R}_{i 4} = ( B {R}_{i 4 , 1} , … , {BR}_{i 4 , ( k + 1 ) \text{?}} ) \qquad ( 22 )$$

$$\text{?} \text{indicates text missing or illegible when filed}$$

In the above equation (16), the computations using the partial outputs BR₁, . . . , and BR_{S}, respectively, and the external product operator are sequentially executed on the initial value c·X^{-b}. The external product operator is defined by the following equation (23). In the following equation (23), TRGSW and TLWE are, respectively, a sample in the TRGSW format and a sample in the TLWE format. This operator is defined as the product of the sample in the TRGSW format and the sample in the TLWE format.

$$\text{?} : TRGSW \times TLWE \to TLWE \qquad ( 23 )$$

The computation of the torus polynomial A and the coefficient b by the external product operator is expressed by the following equation (24). The function DeC_{H,β,ε} in the following equation (24) is a gadget decomposition function of THFE. The gadget decomposition matrix H in the gadget decomposition function is expressed by using the above row vector Hⱼ₃.

$$( A , b ) ↦ A \text{?} b = {Dec}_{H , β , \text{?} ( b )} \cdot A \qquad ( 24 )$$

$$\text{?} \text{indicates text missing or illegible when filed}$$

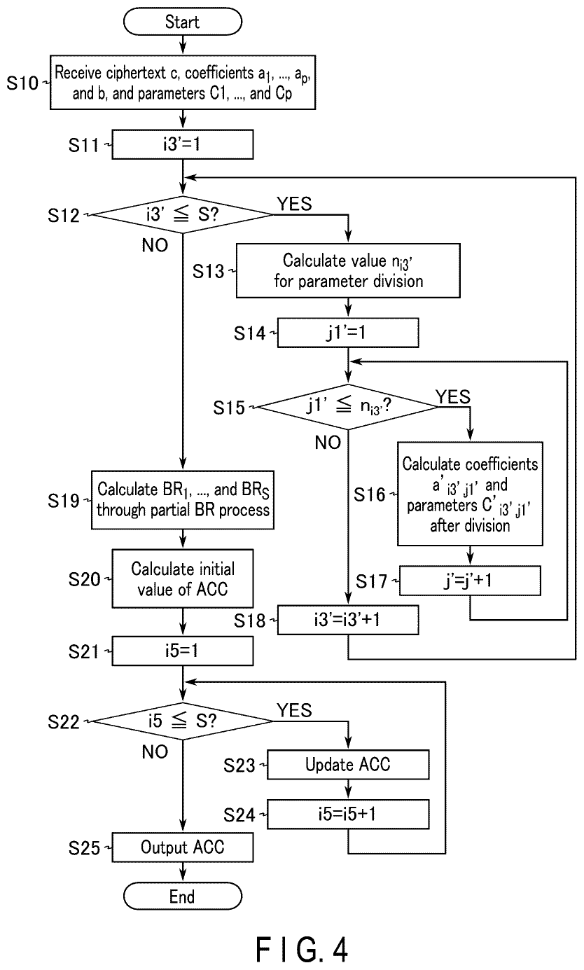

In the embodiment, the computing processing unit 150 uses the mathematical properties as described above to execute the coefficient cyclic computation of the polynomial on the ciphertext c, thereby calculating the output BR. Hereinafter, the blind rotate process using the storage system 3 according to the embodiment will be described with reference to FIG. 4. FIG. 4 is a flowchart illustrating an example of the blind rotate process in the storage system according to the embodiment.

In S10, the computing processing unit 150 receives the ciphertext c, the coefficients a₁, . . . , aₚ, and b, and the parameters C₁, . . . , and Cₚ from the memory management unit 120. In this case, this data has been transmitted from the host 2.

In S11, for example, the parameter group division processing unit 151 initializes the value i3′ (i3′=1). The process then proceeds to S12.

In S12, the parameter group division processing unit 151 determines whether the value i3′ is less than or equal to the value S. If the value i3′ is less than or equal to the value S (YES in S12), the process proceeds to S13. If the value i3′ is more than the value S (NO in S12), the process proceeds to S19.

If the value i3′ is less than or equal to the value S (YES in S12), in S13, the parameter group division processing unit 151 calculates the value n_{i3′}, which is used to divide each of the coefficients a₁, . . . , and aₚ and the parameters C₁, . . . , and Cₚ into an S number of coefficients or parameters. The value n_{i3′} is a value calculated by using the value i3′ in the above equations (10) and (11), instead of the value i3. The process then proceeds to S14.

In S14, the parameter group division processing unit 151 initializes the value j1′ (j′=1). The process then proceeds to S15.

In S15, the parameter group division processing unit 151 determines whether the value j1′ is less than or equal to the value n_{i3′} that has been calculated at the process of S13. If the value j1′ is less than or equal to the value nᵢ₃ (YES in S15), the process proceeds to S16. If the value j1′ is more than the value nᵢ₃ (NO in S15), the process proceeds to S18.

If the value j1′ is less than or equal to the value n_{i3′} (YES in S15), in S16, the parameter group division processing unit 151 uses the value n_{i3′} to calculates the coefficients a′_{i3,j1}, contained in the coefficient group a_{i3′} and the parameters C′_{i3,j1} contained in the parameter group C_{i3′}. The coefficient a′_{i3′,j1′} is a value calculated by using the values i3′ and j1′ in the above equation (9), instead of the values i3 and j1. The parameter C′_{i3′, j1′} is a value calculated by using the values i3′ and j1′ in the above equation (13), instead of the values i3 and j1. The process then proceeds to S17.

In S17, the parameter group division processing unit 151 increments the value j1′ (j1′=j1′+1). The process of S15 is then performed again.

If the value j1′ is more than the value n_{i3′} (NO in S15), in S18, the parameter group division processing unit 151 increments the value i3′(i3′=i3′+1). The process of S12 is then performed again.

In this way, the processes of S16 and S17 are repeated until the value j1′ becomes larger than the value n_{i3′}. As a result, the n_{i3′} number of coefficients a′_{i3′, j1′} (coefficient group) and the n_{i3′} number of parameters C′_{i3′,j1′} (parameter group) are calculated for the value i3′.

In addition, by performing the processes of S12 to S18 until the value i3′ becomes larger than the value S, an S number of coefficient groups a′_{i3′} and an S number of parameter groups C′ᵢ₃, are calculated for the value i3′ (1≤i3′≤S) contained in a range from 1 to the value S. More specifically, the processes of S12 to S18 correspond to the division of each of the coefficients a₁, . . . , and aₚ and the parameters C₁, . . . , and Cₚ into the S number of coefficient groups a′₁, . . . , and a′ₚ and the S number of parameter groups C′₁, . . . , and C′ₚ.

If the value i3′ is more than the value S (NO in S12), in S19, the partial BR processing units 153-1, . . . , and 153-S use, respectively, the S number of coefficient groups a′_{i3′} and the S number of parameter groups C′_{i3′} that have been calculated in the above manner to perform the partial blind rotate process. As a result, the partial BR processing units 153-1, . . . , and 153-S calculate, respectively, the partial outputs BR₁, and BR_{S}. The partial blind rotate process will be described later. The process then proceeds to S20.

In S20, the initial value computing unit 152 uses the coefficient b and the ciphertext c to calculate the initial value c·X^{-b}. The process then proceeds to S21.

In S21, for example, the partial BR output combining unit 154 initializes the value i5 (i5=1). The process then proceeds to S22.

In S22, the partial BR output combining unit 154 determines whether the value i5 is less than or equal to the value S. If the value i5 is less than or equal to the value S (YES in S22), the process proceeds to S23. If the value i5 is more than the value S (NO in S22), the process proceeds to S25.

In S23, the partial BR output combining unit 154 updates the accumulator ACC in accordance with the following equation (25). Equation (25) below means that the accumulator ACC is updated by the computation of the i5-th partial output BRᵢ₅ and the accumulator ACC using the external product operator. More specifically, the accumulator ACC, which is based on a partial output designated by a value less than the value i5, is updated by the i5-th partial output BRᵢ₅. The process then proceeds to S24.

$$ACC ← B {R}_{i 5} \text{?} ACC \qquad ( 25 )$$

In S24, the partial BR output combining unit 154 increments the value i5 (i5=i5+1). The process of S22 is then performed again.

In the processes of S22 to S24, as described above, the partial BR output combining unit 154 uses the S number of partial outputs BR₁, . . . , and BR_{S} to update the accumulator ACC.

If the value i5 is more than the value S (NO in S22), in S25, the partial BR output combining unit 154 outputs, as the output BR, the accumulator ACC updated in this manner to the memory management unit 120. The updated accumulator ACC corresponds to the calculation result of the above equation (16).

After that, the blind rotate process is concluded.

### 1.2.3 Partial Blind Rotate Processes

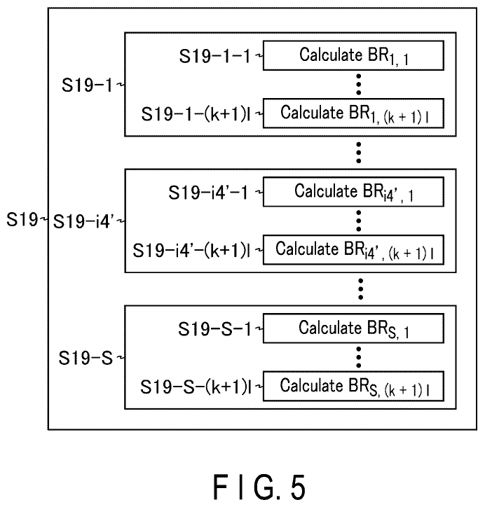

Next, the partial blind rotate processes in the process of S19 in the above blind rotate process will be described with reference to FIG. 5. FIG. 5 is a diagram illustrating an example of the partial blind rotate processes in the storage system according to the embodiment.

The process of S19 includes an S number of processes S19-1 to S19-S. The processes of S19-1 to S19-S are performed, respectively, by the partial BR processing units 153-1 to 153-S. The S number of processes S19-1 to S19-S can be performed in parallel.

Out of the processes S19-1 to S19-S, the process of S19-i4′ includes a (k+1) l number of processes S19-i4′-1 to S19-i4′-(k+1) l. The value i4′ is an integer in a range from 1 to S (1≤i4′≤S). The processes of S19-i4′-1 to S19-i4′-nᵢ₄′ are performed by the partial BR processing unit 153-i4′. The (k+1) l number of processes S19-i4′-1 to S19-i4′-(k+1) l may be performed in parallel by the partial BR processing unit 153-i4′.

In the process of S19-i4′-j3′ out of S19-i4′-1 to S19-i4′-(k+1) l which is designated by the value j3′, the partial BR processing unit 153-i4′ uses the values i4′ and j3′ in the above equation (20) instead of the values i4 and j3 to calculate a sub-partial output BR_{i4′, j3′}. The value j3′ is in a range from 1 to the value (k+1)l(1≤j3′≤(k+1)l).

In this way, the partial BR processing unit 153-i4′ calculates the partial output BR_{i4′} containing an n_{i4′} number of sub-partial outputs, in the process of S19-i4′. In addition, the partial BR processing units 153-1 to 153-S calculate, respectively, an S number of partial outputs BR₁ to BR₈. As described above, the S number of processes S19-1 to S19-S can be performed in parallel, and the (k+1) l number of processes S19-i4′-1 to S19-i4′-(k+1) l can be performed in parallel. As a result of this, the number of processes that can be performed in parallel is S×(k+1)×l, for example.

It should be noted that, in the blind rotate process as described above, the value S is preferably set to the preset value S′. The value S′ is determined in consideration of, for example, an improved processing speed of the parallel process S19, a sequential process in the processes of S12 to S18, and a sequential process in the processes of S22 to S24. In short, the value S′ is a value that can suppress the influence of the increase in the sequential process due to an increased value S. For example, the value S′ is a value at which the processing speed is expected to be the fastest.

### 1.3 Effects of Embodiment

With the foregoing embodiment, the processing speed of the storage device can be improved. Some effects of the embodiment will be described below.

The accelerator 10 in the storage device 1 according to the embodiment is configured to perform a blind rotate process in which a coefficient cyclic computation of a polynomial is executed in a homomorphic manner, on the ciphertext c encrypted with the key K. In this case, the ciphertext c is a sample in the TRLWE format, which is generated by encrypting the torus polynomial v with the key K. The accelerator 10 includes the computing processing unit 150. The computing processing unit 150 uses the ciphertext c, the coefficients a₁ to aₚ related to the ciphertext c, and the parameters C₁ to Cₚ in each of which a value 0 or 1 is encrypted with the key K to perform the blind rotate process. The computing processing unit 150 includes the parameter group division processing unit 151, the S number of partial BR processing units 153-1 to 153-S, and the partial BR output combining unit 154. The parameter group division processing unit 151 performs, based on the coefficients a₁ to aₚ, the division into the S number of coefficient groups a′₁ to a′_{S}, each of which contains a plurality of coefficients. Moreover, the parameter group division processing unit 151 performs, based on the parameters C₁ to Cₚ, the division into the S number of parameter groups C′₁ to C′_{S}, each of which contains a plurality of parameters. The S number of partial BR processing units 153-1 to 153-S are provided in relation to the S number of coefficient groups a′₁ to a′_{S} and the S number of parameter groups C′₁ to C′_{S}. Each of the S number of partial BR processing units 153-1 to 153-S uses the coefficient group out of the coefficient groups a′₁ to a′_{S} which is related to each partial BR processing unit and the parameter group out of the parameter groups C′₁ to C′_{S} which is related to each partial BR processing unit to calculate any one of the partial outputs BR₁ to BR₈. The partial BR output combining unit 154 then combines the partial outputs BR₁ to BR₈ to calculate the output BR of the blind rotate process on the ciphertext c. With the above configuration, the storage system 3 according to the embodiment is configured to be able to use the partial outputs BR₁ to BR₈ that can be calculated independently of one another to calculate the output BR. With the embodiment, the processing speed of the storage device 1 can be improved.

To add to the above, in a comparative example in which a coefficient cyclic computation of a polynomial equation is executed on a ciphertext encrypted with a certain key in a homomorphic manner, for instance, a sequential process that uses a P number of coefficients transmitted from a host and a P number of parameters (a P number of TRGSW samples generated by encrypting a value of 0 or 1 with the above key) related, respectively, to the P number of coefficients is performed. In this comparative example, the process that uses one coefficient out of the P number of coefficients and one parameter out of the P number of parameters is not performed independently because this process is performed using, for example, a result of process that uses a coefficient different from the one coefficient out of the P number of coefficients and a parameter different from the one parameter out of the P parameters. For this reason, the homomorphic coefficient cyclic computation turns out to be a high-load process due to impossibility of performing processes in parallel, thereby causing a problem with a decreased processing speed.

According to the embodiment, the storage device 1 includes the S number of partial BR processing units 153-1 to 153-S. Further, the S number of partial BR processing units 153-1 to 153-S calculate the partial outputs BR₁ to BR₈, which can be calculated independently of one another. With this, the storage device 1 is configured to be able to calculate the partial outputs BR₁ to BR₈ in parallel. It is, therefore, possible to improve the speed of calculating the output BR. Each of the partial BR processing units 153-1 to 153-S can also calculate a plurality of sub-partial outputs in parallel when calculating the partial outputs. With this, it is also possible to improve the speed of calculating the output BR.

### 2 Modification

In the foregoing embodiment, a case where a storage system includes a single accelerator has been illustrated; however, the storage system is limited to this. The storage system may include an accelerator cluster that includes a plurality of accelerators.

As for a configuration and operation of the storage system according to the modification, some differences from the configuration and operation according to the embodiment will be described below.

### 2.1 Configuration

A configuration of the storage system according to the modification will be described.

### 2.1.1 Overall Configuration

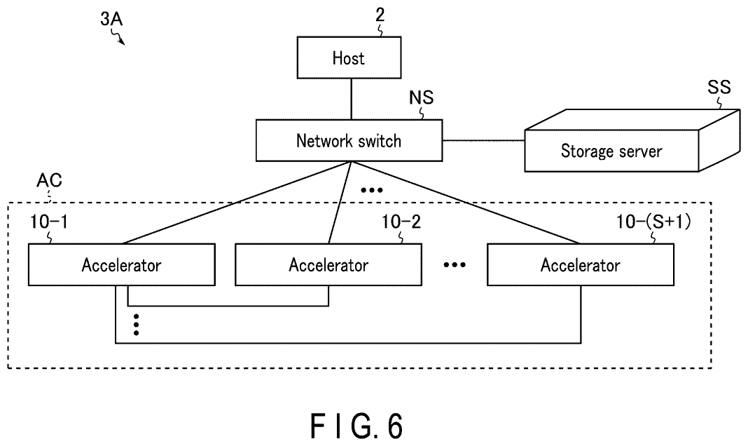

An overall configuration of the storage system according to the modification will be described with reference to FIG. 6. FIG. 6 is a block diagram illustrating an example of the configuration of the storage system according to the modification.

The storage system 3A according to the modification includes a host 2, a network switch NS, a storage server SS, and an accelerator cluster AC.

The network switch NS is connected to the host 2 in such a way that the network switch NS transmits/receives data to or from the host 2. In addition, the network switch NS is connected to the storage server SS in such a way that the network switch NS transmits/receives data to or from the storage server SS. Furthermore, the network switch NS is connected to the accelerator cluster AC in such a way that the network switch NS transmits/receives data to or from the accelerator cluster AC.

The storage server SS includes, for example, a semiconductor memory that stores data of an SSD or other storage in a nonvolatile manner. The storage server SS stores data transmitted from the host 2 via the network switch NS.

The accelerator cluster AC includes an (S+1) number of accelerators 10-1, . . . , and 10-(S+1). Hereinafter, in a case where the accelerators 10-1, . . . , and 10-(S+1) are not distinguished from one another, each of the accelerators 10-1, . . . , and 10-(S+1) is also referred to simply as the accelerator 10. Each accelerator 10 is configured to be able to transmit/receive data to or from another accelerator 10 out of the (S+1) number of accelerators 10, for example, via the network switch NS. It should be noted that the S number of accelerators 10-2, . . . , and 10-(S+1) are related, respectively, to the S number of partial blind rotate processes in the foregoing embodiment, for example. A configuration of the accelerator cluster AC will be described later.

The accelerator cluster AC receives data used for the blind rotate process, from the host 2 via the network switch NS. The accelerator cluster AC then uses this data to perform the blind rotate process. The accelerator cluster AC then transmits, for example, an output BR (output data) of this process to the host 2 via the network switch NS.

With this configuration, in the modification, the host 2 stores, for example, the input data and the output BR (output data) in the storage server SS via the network switch NS. If the host 2 includes a local storage that is not illustrated, the host 2 may store the input data and the output data in this local storage, instead of storing the input data and the output data in the storage server SS. The local storage is, for example, a semiconductor memory that stores data of an SSD or other storage in a nonvolatile manner.

### 2.1.2 Accelerator

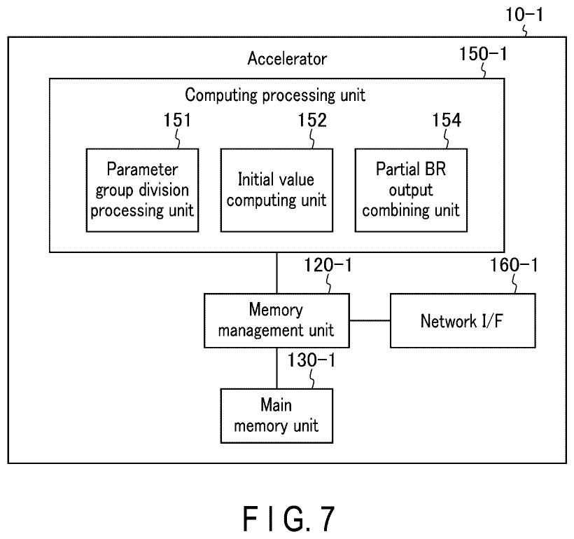

A configuration of the accelerator 10-1 according to the modification will be described with reference to FIG. 7. FIG. 7 is a block diagram for explaining an example of a configuration of an accelerator included in the accelerator cluster of the storage device according to the modification.

The accelerator 10-1 includes a memory management unit 120-1, a main memory unit 130-1, a computing processing unit 150-1, and a network interface circuit (network I/F) 160-1.

The memory management unit 120-1 intensively controls the accelerator 10-1, for example. The memory management unit 120-1 receives a command from the host 2 and data used for a process to be performed in response to this command, via the network interface circuit 160-1. In addition, the memory management unit 120-1 transmits/receives data related to the above process to or from the accelerators 10-2 to 10-(S+1) via the network interface circuit 160. When a calculation process is performed in the accelerator 10-1, the memory management unit 120-1 transmits data used for this calculation process to the computing processing unit 150-1. The memory management unit 120-1, in turn, receives data of an intermediate, final, and other results of the calculation process from the computing processing unit 150-1. The memory management unit 120-1 stores, in the main memory unit 130-1, for example, data transmitted from the host 2, the accelerators 10-2 to 10-(S+1), and the computing processing unit 150-1. In addition, the memory management unit 120-1 transmits the process result (final result) to the host 2 via the network interface circuit 160-1.

In this case, the memory management unit 120-1 may also be configured to intensively control the processes in the accelerators 10-2 to 10-(S+1), in response to a command from the host 2.

A configuration of the main memory unit 130-1 is the same as the configuration of the main memory unit 130 in the embodiment.

The computing processing unit 150-1 includes a parameter group division processing unit 151, an initial value computing unit 152, and a partial BR output combining unit 154. Configurations of the parameter group division processing unit 151, the initial value computing unit 152, and the partial BR output combining unit 154 are substantially the same as the configurations in the embodiment.

The network interface circuit 160-1 is configured to be able to transmit/receive data to or from each of the network switch NS and the accelerators 10-2 to 10-(S+1) via a network.

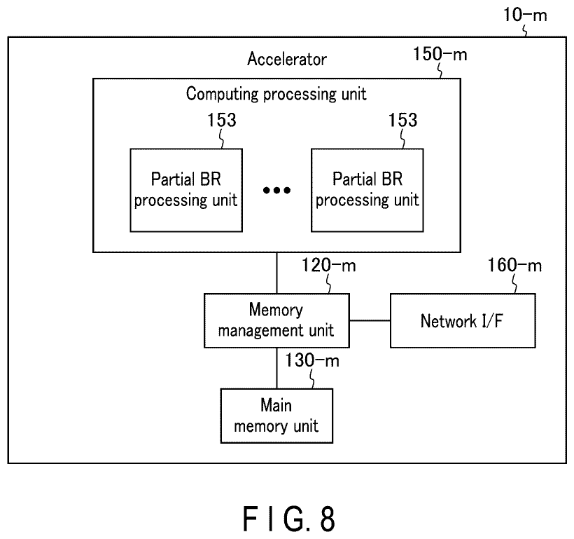

Next, configurations of the accelerators 10-2 to 10-(S+1) according to the modification will be described with reference to FIG. 8. FIG. 8 is a block diagram for explaining an example of a configuration of accelerators included in the accelerator cluster of the storage device according to the modification.

The accelerators 10-2 to 10-(S+1) are provided, respectively, for example, so as to calculate partial outputs BR₁ to BR₈ in the embodiment. Configurations of the accelerators 10-2 to 10-(S+1) can be the same as each other. A description will be given below of, out of the configurations of the accelerators 10-2 to 10-(S+1), the configuration of an accelerator 10-m designated by the value m. For example, the value m is an integer in a range from 2 to the value (S+1) (2≤m≤(S+1)). The accelerator 10-m includes a memory management unit 120-m, a main memory unit 130-m, a computing processing unit 150-m, and a network interface circuit 160-m.

The memory management unit 120-m intensively controls the accelerator 10-m, for example. The memory management unit 120-m controls the accelerator 10-m, for example, in response to a command from the host 2 or under the control of the memory management unit 120-1 in the accelerator 10-1. The memory management unit 120-m transmits/receives data to or from the host 2 and an accelerator out of the accelerators 10-1 to 10-(S+1) which is different from the accelerator 10-m, via the network interface circuit 160-m. When a process is performed in the accelerator 10-m, the memory management unit 120-m transmits data used for this process to the computing processing unit 150-m. The memory management unit 120-m, in turn, receives, from the computing processing unit 150-m, data on an intermediate result of the process, a final result of the process, and other results in the accelerator 10-m. The memory management unit 120-m stores, in the main memory unit 130-m, for example, data transmitted from the host 2, an accelerator out of the accelerators 10-1 to 10-(S+1) which is different from the accelerator 10-m, and the computing processing unit 150-m. In addition, the memory management unit 120-m transmits the process result (partial output) in the accelerator 10-m to the accelerator 10-1 via the network interface circuit 160-1.

A configuration of the main memory unit 130-m can be the same as the configuration of the main memory unit 130-1.

The computing processing unit 150-m includes a plurality of partial BR processing units 153-1, . . . , and 153-n2. The value n2 is, for example, an integer equal to or more than 2. The plurality of partial BR processing units 153-1, . . . , and 153-n2 in the accelerator 10-m are configured to calculate a partial output BRm related to the value m. The plurality of partial BR processing units 153-1, . . . , and 153-n2 are configured to calculate an nm number of sub-partial outputs, for example, when the partial output BRm is calculated.

The network interface circuit 160-m is configured to be able to transmit/receive, for example, via the network, data to or from each of the network switch NS and an accelerator out of the accelerator 10-1 to 10-(S+1) which is different from the accelerator 10-m.

In the configuration of the accelerator cluster AC according to the modification as described above, the accelerator 10-1 receives, for example, ciphertext c, coefficients a₁, . . . , aₚ, and b, and parameters C₁, . . . , and Cₚ, from the host 2. The parameter group division processing unit 151 in the accelerator 10-1 uses the coefficients a₁, . . . , aₚ, and b and the parameters C₁, . . . , and Cₚ to perform a division into an S number of coefficient groups a′₁, . . . , and a′_{S} and an S number of parameter groups C′₁, . . . , and C′_{S}. In addition, the initial value computing unit 152 in the accelerator 10-1 calculates an initial value c·X^{-b} of an accumulator ACC.

Each of the accelerators 10-2 to 10-(S+1) receives, for example, out of the S number of coefficient groups a′₁, . . . , and a′_{S} and the S number of parameter groups C′₁, . . . , and C′_{S}, a coefficient group and a parameter group related to this accelerator 10, from the accelerator 10-1. The accelerator 10 uses the received coefficient group and parameter group to perform the partial blind rotate process related to this accelerator 10. The accelerator 10 then transmits, to the accelerator 10-1, the partial output that has been calculated through this partial blind rotate process. In this way, the S number of partial blind rotate processes can be performed in parallel by the accelerator 10-2 to 10-(S+1).

The partial BR output combining unit 154 in the accelerator 10-1 then uses the initial value c·X^{-b} of the accumulator ACC which has been calculated by the initial value computing unit 152 in the accelerator 10-1 and the S number of partial outputs BR₁ to BR₈ that have been calculated by the accelerators 10-2 to 10-(S+1) to calculate the output BR, as in the foregoing embodiment.

In the operation according to the modification, the blind rotate process is performed by using the plurality of accelerators 10-1 to 10-(S+1), instead of being performed by a single accelerator. In the operation according to the modification, when the partial outputs BR₁ to BR₈ are calculated, a plurality of sub-partial outputs related to these partial outputs are calculated by the plurality of partial BR processing units 153 in each accelerator. Other operations may be substantially the same.

The storage system 3A according to the modification can also produce the same effects as in the foregoing embodiment.

### 3 Others

While certain embodiments have been described, these embodiments have been presented by way of example only, and are not intended to limit the scope of the inventions. Indeed, the novel embodiments described herein may be embodied in a variety of other forms. Furthermore, various omissions, substitutions, and changes in the form of the embodiments may be made without departing from the spirit of the inventions. The accompanying claims and their equivalents are intended to cover such forms or further embodiments as would fall within the scope and spirit of the inventions.

1. A controller configured to execute a first computation by which a coefficient cyclic computation of a polynomial is executed in a homomorphic manner on first ciphertext encrypted with a first key, the controller comprising:
a computing processing unit configured to use the first ciphertext, a plurality of first coefficients related to the first ciphertext, and a plurality of first parameters in each of which a value 0 or 1 is encrypted with the first key to execute the first computation, wherein
the computing processing unit includes:
a parameter group division processing unit configured to perform, based on the first coefficients, a division into an S number of first coefficient groups, each of which contains a plurality of second coefficients and to perform, based on the first parameters, a division into an S number of first parameter groups, each of which contains a plurality of second parameters and which are related, respectively, to the S number of first coefficient groups;
an S number of partial processing units which are provided in relation to the S number of first coefficient groups and the S number of first parameter groups, each of the S number of partial processing units using the relevant first coefficient group out of the S number of first coefficient groups and the relevant first parameter group out of the S number of first parameter groups, each of the S number of partial processing units calculating a partial output; and
an output combining unit configured to combine the S number of partial outputs that have been calculated, respectively, by the S number of partial processing units to calculate a result of the first computation on the first ciphertext.

2. The controller according to claim 1, wherein
the S number of partial processing units are configured to be able to calculate the S number of partial outputs in parallel.

3. The controller according to claim 1, further comprising a host interface circuit configured to be able to communicate with a host, wherein
the host interface circuit is configured to receive, from the host, a command of the first computation, the first ciphertext, the first coefficients, and the first parameters and to transmit the result to the host as the output.

4. The controller according to claim 1, wherein
the first ciphertext is ciphertext generated for a secure calculation, and
the first computation is a computation by which noise in the first ciphertext is reduced.

5. The controller according to claim 1, wherein
the output combining unit is configured to calculate the result through a computation sequentially using the S number of partial outputs.

6. The controller according to claim 5, further comprising a management unit, wherein
the management unit is configured to receive the command of the first computation, the first ciphertext, the first coefficients, and the first parameters from a host outside the controller and to, in response to the command, cause the computing processing unit to execute the first computation using the first ciphertext, the first coefficients, and the first parameters.

7. The controller according to claim 6, further comprising a storage unit, wherein
the management unit is configured to receive the S number of partial outputs from the computing processing unit and to store, in the storage unit, the first ciphertext, the first coefficients, the first parameters, and the S number of partial outputs.

8. The computing system according to claim 1, wherein
the first ciphertext is a sample in a TRLWE format.

9. The computing system according to claim 1, wherein
the first computation is a blind rotate process.

10. The computing system according to claim 1, wherein
the result of the first computation is a sample in a TRLWE format.

11. A computing system configured to execute a first computation by which a coefficient cyclic computation of a polynomial is executed in a homomorphic manner on first ciphertext encrypted with a first key, the computing system comprising:
a first controller and an S number of second controllers configured to communicate with each other, wherein
the first controller includes:
a parameter group division processing unit configured to perform, based on a plurality of first coefficients related to the first ciphertext, a division into an S number of first coefficient groups, each of which contains a plurality of second coefficients and which are related, respectively, to the S number of second controllers and to perform, based on a plurality of first parameters in each of which a value 0 or 1 is encrypted with the first key, a division into an S number of first parameter groups, each of which contains a plurality of second parameters and which are related, respectively, to the S number of second controllers; and
an output combining unit, and
each of the S number of second controllers includes a computing processing unit configured to use the first coefficient group out of the S number of first coefficient groups which is related to each second controller and the first parameter group out of the S number of first parameter groups which is related to each second controller, to calculate a partial output, and
the output combining unit in the first controller configured to combine the S number of partial outputs that have been calculated, respectively, by the S number of second controllers to calculate a result of the first computation.

12. The computing system according to claim 11, wherein
each of the S number of second controllers is configured to be able to calculate the S number of partial outputs in parallel.

13. The computing system according to claim 12, wherein
each computing processing unit includes a plurality of partial processing units, and
the S number of partial outputs are calculated, respectively, by a plurality of sub-partial outputs, and
the partial processing units are configured to be able to calculate, in parallel, the sub-partial outputs related to each computing processing unit.

14. The computing system according to claim 11, wherein
the first controller is configured to be able to communicate with a host,
the first controller is configured to receive, from the host, a command of the first computation, the first ciphertext, the first coefficients, and the first parameters and to transmit the result to the host as the output.

15. The computing system according to claim 11, wherein
the first ciphertext is ciphertext generated for secure calculation, and
the first computation is a computation by which noise in the first ciphertext is lowered.

16. The computing system according to claim 11, wherein
the output combining unit is configured to calculate the result through a computation sequentially using the S number of partial outputs.

17. The computing system according to claim 11, wherein
the first ciphertext is a sample in a TRLWE format.

18. The computing system according to claim 11, wherein
the first computation is a blind rotate process.

19. The computing system according to claim 17, wherein
the result of the first computation is a sample in a TRLWE format.
